(19) United States
(12) Patent Application Publication
(10) Pub. No.: US 2002/0028401 A1
(43) Pub. Date: Mar. 7, 2002

(54) Use of iron azo complex compounds as charge control agents

(75) Inventors: Hans-Tobias Macholdt, Darmstadt-Eberstadt (DE); Eduard Michel, Frankfurt am Main (DE); Ruediger Baur, Eppstein/Ts (DE); Dominique Pflieger, Tagsdorf (FR); Bansi Lai Kaul, Biel-Benken (CH)

Correspondence Address: Clariant Corporation, Industrial Property Department, 4331 Chesapeake Drive, Charlotte, NC, 28216, US

(73) Assignee: Clariant GmbH

(21) Appl. No.: 09/894,319

(22) Filed: Jun. 28, 2001

(30) Foreign Application Priority Data
Jul. 1, 2000 (DE) 10032138.0

(51) Int. Cl. C09D 11/00; G03G 9/00

(52) U.S. Cl. 430/108.23; 524/168; 106/31.52

(57) ABSTRACT

Iron azo complex compounds of the formula (I) are used as charge control agents in electrophotographic toners and developers, in powder coating materials, electret materials and in electrostatic separation processes, in inkjet inks and in color filters.

[chemical structure]

### CROSS-REFERENCES TO RELATED APPLICATIONS

The present invention is described in the German priority application No. 10032138, filed Jul. 1, 2000, which is hereby incorporated by reference as is fully disclosed herein.

### BACKGROUND OF THE INVENTION

The present invention lies within the field of charge control agents, i.e., components which selectively influence electrostatic charging in a matrix.

In electrophotographic recording processes a latent charge image is produced on a photoconductor. This latent charge image is developed by applying an electrostatically charged toner which is then transferred to, for example, paper, textiles, foils or plastic and is fixed by means, for example, of pressure, radiation, heat or the action of solvent. Typical toners are one- or two-component powder toners (also known as one- or two-component developers); also used are specialty toners, such as magnetic toners, liquid toners or polymerization toners, for example. By polymerization toners are meant those toners which are formed by, for example, suspension polymerization (condensation) or emulsion polymerization and lead to improved particle properties in the toner. Also meant are those toners produced basically in nonaqueous dispersions.

One measure of the quality of a toner is its specific charge q/m (charge per unit mass). In addition to the sign and level of the electrostatic charge, the principal, decisive quality criteria are the rapid attainment of the desired charge level, the constancy of this charge over an extended activation period and the insensitivity of the toner to climatic effects, such as temperature and atmospheric humidity.

Both positively and negatively chargeable toners are used in copiers and laser printers, depending on the type of process and type of apparatus.

To obtain electrophotographic toners or developers having either a positive or negative charge, it is common to add charge control agents. Since the charge of toner binders is often heavily dependent on the activation period, the function of a charge control agent is, on the one hand, to set the sign and level of the toner charge and, on the other hand, to counteract the charge drift of the toner binder and to provide for constancy of the toner charge. Another important practical requirement is that the charge control agents should have sufficient thermal stability and good dispersibility. Typical temperatures at which charge control agents are incorporated into the toner resins, when using kneading apparatus or extruders, are between 100° C. and 200° C. Accordingly, thermal stability at 200° C. is of great advantage. It is also important for the thermal stability to be ensured over a relatively long period (about 30 minutes) and in a variety of binder systems.

For effective dispersibility it is of advantage for the charge control agent not to exhibit any waxlike properties or any tackiness and to have a melting or softening point of >150° C., better still >200° C. Tackiness frequently leads to problems in the course of metered addition to the toner formulation, and low melting or softening points may result in failure to achieve homogeneous distribution in the course of incorporation by dispersion, since the material amalgamates in the form of droplets in the carrier material.

Typical toner binders are addition polymerization, polyaddition and polycondensation resins, such as styrene, styrene-acrylate, styrene-butadiene, acrylate, polyester and phenol-epoxy resins, and also cycloolefin copolymers, individually or in combination, which may also include further components, examples being colorants, such as dyes and pigments, waxes or flow assistants, or may have these components added subsequently, such as highly disperse silicas.

Charge control agents may also be used to improve the electrostatic charge of powders and coating materials, especially in triboelectrically or electrokinetically sprayed powder coating materials as are used to coat surfaces of articles made from, for example, metal, wood, plastic, glass, ceramic, concrete, textile material, paper or rubber. The powder coating material, or the powder, receives its electrostatic charge, in general, by one of the two following methods:

In the case of the corona method, the powder coating material or powder is guided past a charged corona and is charged in the process; in the case of the triboelectric or electrokinetic method, the principle of frictional electricity is utilized. It is also possible to combine the two methods. The powder coating material or powder in the spray apparatus receives an electrostatic charge which is opposite to the charge of its friction partner, generally a hose or spray pipe made, for example, from polytetrafluoroethylene.

Typical powder coating resins employed are epoxy resins, carboxyl- and hydroxyl-containing polyester resins, polyurethane resins and acrylic resins, together with the customary hardeners. Resin combinations are also used. For example, epoxy resins are frequently employed in combination with carboxyl- and hydroxyl-containing polyester resins.

It has additionally been found that charge control agents are able to improve considerably the charging and the charge stability properties of electret materials, especially electret fibers (DE-A-43 21 289). Typical electret materials are based on polyolefins, halogenated polyolefins, polyacrylates, polyacrylonitriles, polystyrenes or fluoropolymers, for example polyethylene, polypropylene, polytetrafluoroethylene and perfluorinated ethylene and propylene, or on polyesters, polycarbonates, polyamides, polyimides, polyether ketones, on polyarylene sulfides, especially polyphenylene sulfides, on polyacetals, cellulose esters, polyalkylene terephthalates, and mixtures thereof. Electret materials, especially electret fibers, can be used, for example, to filter (very fine) dusts. The electret materials can receive their charge by corona or triboelectric charging.

Additionally, charge control agents can be used in electrostatic separation processes, especially in processes for the separation of polymers. For instance, using the example of the externally applied charge control agent trimethylphenylammonium tetraphenylborate, Y. Higashiyama et al. (J. Electrostatics 30 (1993) 203-212) describe how polymers can be separated from one another for recycling purposes. Without charge control agents, the triboelectric charging characteristics of low-density polyethylene (LDPE) and high-density polyethylene (HDPE) are extremely similar. Following the addition of charge control agent, LDPE takes on a highly positive and HDPE a highly negative charge, and the materials can thus be separated easily. In addition to the external application of the charge control agents it is also possible to incorporate them into a polymer in order, for example, to shift the position of the polymer within the triboelectric voltage series and to obtain a corresponding separation effect. In this way it is possible to separate other polymers as well, such as polypropylene (PP) and/or polyethylene terephthalate (PET) and/or polyvinyl chloride (PVC), from one another.

Salt minerals can likewise be separated if they are admixed beforehand (surface conditioning) with an agent which improves the substrate-specific electrostatic charging (A. Singewald et al., Zeitschrift fur Physikal. Chem. 124 (1981) 223-248).

Charge control agents are employed, furthermore, as “electroconductivity providing agents” (ECPAs) in inks for inkjet printers (JP-05-163 449). JP-A-62-129 358 discloses iron azo complex compounds containing unsubstituted naphthyl radicals, but having poor light stability and a level of charging which is in need of improvement.

### SUMMARY OF THE INVENTION

The object of the present invention was to find effective and ecotoxicologically compatible charge control agents, containing in particular no toxic heavy metals. Furthermore, these compounds should be readily dispersible, without decomposition, in various toner binders employed in practice, such as polyesters, polystyrene-acrylates or polystyrene-butadienes/epoxy resins and also cycloolefin copolymers. Furthermore, their action should be largely independent of the resin/carrier combination, in order to open up broad applicability. They should likewise be readily dispersible, without decomposition, in common powder coating binders and electret materials, such as polyester (PES), epoxy, PES-epoxy hybrid, polyurethane, acrylic systems and polypropylenes.

In terms of their electrostatic efficiency the charge control agents should be active even at very low concentration (1% or less) and should not lose this efficiency when in conjunction with carbon black or other colorants. It is known of colorants that they can affect—in some cases lastingly—the triboelectric charging of toners.

Furthermore, the compounds used in accordance with the invention ought to be suitable for use as colorants in inkjet inks, so that good water solubility and high light stability are desirable.

Surprisingly it has now become evident that iron azo complex compounds described below have advantageous charge control properties, especially a high negative charge, and high thermal stabilities, the charge control property being lost neither by combination with carbon black nor by combination with other colorants. Furthermore, the compounds are readily compatible with the customary toner, powder coating and electret binders and are easy to disperse. Moreover, the compounds are readily water-soluble and possess high light stability.

### DESCRIPTION OF THE PREFERRED EMBODIMENTS

The present invention provides for the use of iron azo complex compounds of the formula (1) as charge control agents in electrophotographic toners and developers, in powder coating materials, electret materials and in electrostatic separation processes, in inkjet inks and in color filters,

[chemical structure]

in which

R₁ is hydrogen or a radical of the formula

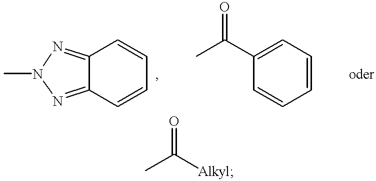

R₂ and R₃ are identical or different and are hydrogen, alkyl, alkoxyalkyl, cycloalkyl or aryl;

R₄ is hydrogen or hydroxyl;

R₅ is hydrogen, alkyl, alkoxyalkyl or cycloalkyl; and

R₆ is hydrogen or a group of the formula (2)

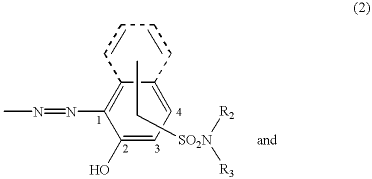

R₇⁺ is ammonium or aliphatic, alicyclic or heterocyclic ammonium.

In the above definitions of the radicals R¹ to R⁶, “alkyl” is preferably (C₁-C₄)-alkyl, especially methyl, ethyl, n-propyl, i-propyl, n-butyl and t-butyl.

“Alkoxyalkyl” is preferably (C₁-C₄)-alkoxy-(C₁-C₄)-alkyl, especially methoxy(C₁-C₄)-alkyl, such as methoxypropyl for example.

“Cycloalkyl” is preferably C₅-C₆-cycloalkyl.

“Aryl” is preferably unsubstituted C₆-C₁₀-aryl or C₆-C₁₀-aryl substituted by 1, 2 or 3 of the following substituents:

halogen, preferably Cl and Br, OH, C₁-C₄-alkyl, C₁-C₄-alkoxy, cyano, NO₂, C₁-C₄-alkylcarbonyl, SCN, C₁-C₄-alkoxycarbonyl, benzoyl, phenoxycarbonyl, C₁-C₄-alkylcarbonyloxy, aminocarbonyl, mono-(C₁-C₄-alkyl)-aminocarbonyl, di-(C₁-C₄-alkyl )-aminocarbonyl, mono-(C₁-C₄-alkoxy-C₂-C₄-alkyl )-aminocarbonyl, di-(C₁-C₄-alkoxy-C₂-C₄-alkyl)-aminocarbonyl, aminosulfonyl, mono-(C₁-C₄-alkyl)-aminosulfonyl, di-(C₁-C₄-alkyl)-aminosulfonyl, mono-(C₁-C₄-alkoxy-C₂-C₄-alkyl)-aminosulfonyl, di-(C₁-C₄-alkoxy-C₂-C₄-alkyl)-aminosulfonyl and phenylaminosulfonyl.

R₇⁺ is preferably ammonium, mono-(C₅-C₂₀-alkyl)-ammonium, di-(C₅-C₂₀-alkyl)-ammonium, tri-(C₅-C₂₀-alkyl)ammonium, tri-(C₅-C₂₀-alkyl-)methyl-ammonium, preferably mono-C₈-C₁₆-alkylammonium, di-(C₈-C₁₆-alkyl)-ammonium, tri-(C₈-C₁₆-alkyl)-ammonium, with particular preference 4-amino-2,2,6,6-tetra-(C₁-C₂-alkyl)-piperidinium, 4-hydroxy-2,2,6,6-tetra(C₁-C₂-alkyl)-piperidinium, 4-keto-2,2,6,6-tetra(C₁-C₂)alkyl-piperidinium and tri-(C₈-C₁₈-alkyl-)methyl-ammonium.

Very particular preferred groups R₇⁺ are monooctylammonium, 2-ethylhexyl-ammonium, 4-amino-2,2,6,6-tetramethylpiperidinium, 4-hydroxy-2,2,6,6-tetramethyl-piperidinium, 4-keto-2,2,6,6-tetramethylpiperidinium and tri-(C₁₀-C₁₆-alkyl)-methyl-ammonium.

Preferably, the sulfamoyl groups are located in position 4 or 5 on the phenyl ring, or in position 4 or 6 on the naphthyl ring system.

Particularly preferred compounds in the context of the present invention are those of the formula (Ia)

[chemical structure]

or mixtures thereof, in which R₂, R₃ and R₆ are as defined above and the group —SO₂NR₂R₃ is in position 4 or 5 if the ring is a phenyl ring or is in position 4 or 6 if the ring system is a naphthyl ring system.

The preparation of the compounds of the formula (I) is described in WO 98/05717. The compounds of the formula (I) may be obtained as symmetrical compounds or asymmetrical compounds. By symmetrical compounds are meant those in which both radicals R₆ are hydrogen or both radicals R₆ are azosulfamoylphenyl of the formula (2). Asymmetrical compounds are those in which the radicals R₆ each have different meanings.

Preference is given in the context of the present invention to the asymmetrical compounds, or to mixtures of asymmetrical with symmetrical compounds.

The iron azo complex compounds used in accordance with the invention can be matched precisely to the particular resin/toner system. A further technical advantage of these compounds is that they are inert toward the various binder systems and can therefore be employed widely, it being particularly significant that they are not dissolved in the polymer matrix but rather are present as small, very finely divided solid structures. Furthermore, they exhibit high and generally constant charge control properties and also good thermal stabilities. Moreover, the Fe azo complex compounds used in accordance with the invention are free-flowing and possess good dispersibility.

Dispersion means the distribution of one substance within another, i.e. in the context of the invention the distribution of a charge control agent in the toner binder, powder coating binder or electret material.

It is known that crystalline substances in their coarsest form are present as agglomerates. To achieve homogeneous distribution within the binder, these agglomerates must be disrupted by the dispersing operation into smaller aggregates or, ideally, into primary particles. The particles of charge control agent present in the binder following dispersion should be smaller than 1 μm, preferably smaller than 0.5 μm, with a narrow particle size distribution being of advantage.

For the particle size, defined by the d₅₀ value, there are optimum ranges of activity depending on the material. For instance, coarse particles (1 mm) can in some cases not be dispersed at all or can be dispersed only with considerable investment of time and energy, whereas very fine particles in the submicron range harbor a heightened safety risk, such as the possibility of dust explosion. The particle size and form is established and modified either by the synthesis and/or by aftertreatment. The required property is frequently possible only through controlled aftertreatment, such as milling and/or drying. Various milling techniques are suitable for this purpose. Examples of advantageous technologies are airjet mills, cutting mills, hammer mills, bead mills and impact mills.

The binder systems mentioned in connection with the present invention are, typically, hydrophobic materials. High levels of water in the charge control agent can either oppose wetting or else promote dispersion (flushing). The practicable moisture content is therefore specific to the particular material.

The compounds employed in accordance with the invention feature the following chemical/physical properties:

The water content, determined by the Karl-Fischer method, is between 0.001% and 30%, preferably between 0.01 and 25% and, with particular preference, between 0.1 and 15%, it being possible for the water to be in adsorbed and/or bonded form, and for its proportion to be adjusted by the action of heat at up to 200° C. and reduced pressure down to 10⁻⁸ torr or by addition of water, or by storage under defined air humidity conditions.

The particle size, determined by means of evaluation by light microscope or by laser light scattering, and defined by the d₅₀-value, is between 0.01 μm and 1000 μm, preferably between 0.1 and 500 μm, and with very particular preference between 0.5 and 400 μm. It is particularly advantageous if milling results in a narrow particle size. Preference is given to a range Δ(d₉₅-d₅₀) of less than 500 μm, in particular less than 400 μm.

The iron azo complex compounds employed in accordance with the invention can also be combined with further positive or negative charge control agents in order to obtain good performance chargeabilities, the overall concentration of the charge control agents being judiciously between 0.01 and 50% by weight, preferably between 0.05 and 20% by weight, with particular preference between 0.1 and 5% by weight, based on the overall weight of the electrophotographic toner, developer, powder or powder coating material.

Examples of suitable further charge control agents are:

triphenylmethanes; ammonium and immonium compounds, iminium compounds; fluorinated ammonium and fluorinated immonium compounds; biscationic acid amides; polymeric ammonium compounds; diallylammonium compounds; aryl sulfide derivatives, phenol derivatives; phosphonium compounds and fluorinated phosphonium compounds; calix(n)arenes, cyclically linked oligosaccharides (cyclodextrins) and their derivatives, especially boric ester derivatives, interpolyelectrolyte complexes (IPECs); polyester salts; metal complex compounds, especially salicylate metal complexes and salicylate nonmetal complexes, hydroxycarboxylic acid metal complexes and hydroxycarboxylic acid nonmetal complexes, benzimidazolones; azines, thiazines or oxazines, which are listed in the Colour Index as Pigments, Solvent Dyes, Basic Dyes or Acid Dyes.

Particular preference is given to the charge control agents specified below, which can be combined individually or in combination with one another with the iron azo complex compounds:

triphenylmethanes, as described for example in US-A-5 051 585; ammonium and immonium compounds, as described for example in US-A-5 051 676; fluorinated ammonium and fluorinated immonium compounds, as described for example in US-A-5 069 994; biscationic acid amides, as described for example in WO 91/10172; diallylammonium compounds, as described for example in DE-A-4 142 541, DE-A-4 029 652 or DE-A-4 103 610; alkyl sulfide derivatives, as described for example in DE-A-4 031 705; phenol derivatives, as described for example in EP-A-0 258 651; phosphonium compounds and fluorinated phosphonium compounds, as described for example in US-A-5 021 473 and US-A-5 147 748; calix(n)arenes, as described for example in EP-A-0 385 580; benzimidazolones, as described for example in EP-A-0 347 695; cyclically linked oligosaccharides, as described for example in DE-A-4 418 842; polyester salts, as described for example in DE-A-4 332 170; cyclooligosaccharide compounds, as described for example in DE-A-197 11 260; interpolyelectrolyte complexes, as described for example in DE-A-197 32 995;

salt-like structured silicates, as described for example in DE-A-1 99 57 245.

Also suitable, especially for liquid toners, are surface-active, ionic compounds and those known as metal soaps.

Particularly suitable are alkylated arylsulfonates, such as barium petronates, calcium petronates, barium dinonylnaphthalenesulfonates (basic and neutral), calcium dinonylsulfonate or Na dodecylbenzenesulfonate, and polyisobutylenesuccinimides (Chevron's Oloa 1200). Also suitable are soya lecithin and N-vinylpyrrolidone polymers. Also suitable are sodium salts of phosphated monoglycerides and diglycerides with saturated and unsaturated substituents, AB diblock copolymers of A: polymers of 2-(N;N)di-methylaminoethyl methacrylate quaternized with methyl p-toluenesulfonate, and B: poly-2-ethylhexyl methacrylate. Also suitable, especially in liquid toners, are divalent and trivalent carboxylates, especially aluminum tristearate, barium stearate, chromium stearate, magnesium octoate, calcium stearate, iron naphthalite and zinc naphthalite. Also suitable are chelating charge control agents (EP 0 636 945 A1), metallic (ionic) compounds (EP 0 778 501 A1), phosphate metal salts, such as described in JP-9-106107. Also suitable are azines of the following Colour Index Numbers: C.I. Solvent Black 5, 5:1, 5:2, 7, 31 and 50; C.I. Pigment Black 1, C.I. Basic Red 2 and C.I. Basic Black 1 and 2.

The iron azo complex compounds used in accordance with the invention are incorporated individually or in combination with one another or with further charge control agents, mentioned above, in a concentration of from 0.01 to 50% by weight, preferably from 0.05 to 20% by weight, with particular preference from 0.1 to 5.0% by weight, based on the overall mixture, into the binder of the respective toner, developer, coating material, powder coating material, electret material or of the polymer which is to be electrostatically separated, said incorporation being homogeneous and taking place, for example, by means of extrusion or kneading, beadmilling or using an Ultraturrax (high-speed stirrer). In this context the compounds employed in accordance with the invention can be added as dried and milled powders, dispersions or solutions, presscakes, masterbatches, preparations, made-up pastes, as compounds applied from aqueous or nonaqueous solution to appropriate carriers such as silica gel, TiO₂, Al₂O₃ or carbon black, for example, or mixed with such carriers, or added in some other form. Similarly, the compounds used in accordance with the invention can also in principle be added even during the preparation of the respective binders, i.e., in the course of their addition polymerization, polyaddition or polycondensation.

In order to prepare electrophotographic color toners it is possible to add further colorants, such as organic color pigments, inorganic pigments or dyes. The organic color pigments may be from the group of the azo pigments or polycyclic pigments or mixed crystals (solid solutions) of such pigments.

The mixtures may be prepared in the form of the powders, by mixing of presscakes, spray-dried presscakes, masterbatches, and by dispersing (extrusion, kneading, roll-mill methods, beadmills, Ultraturrax) in the presence of a carrier material in solid or liquid form (aqueous and nonaqueous inks) and also by flushing in the presence of a carrier material. Where the colorant is used with high water or solvent fractions (>5%), mixing may also take place in the presence of elevated temperatures and with vacuum assistance. The flushing operation may take place in the presence or absence of organic solvents and of waxes.

Especially for increasing the brilliance, but also for shading the hue, mixtures with organic dyes are appropriate, especially those dyes which have or which give a black color. Preferred such dyes include:

water-soluble dyes, such as Direct, Reactive and Acid Dyes, and also solvent-soluble dyes, such as Solvent Dyes, Disperse Dyes and Vat Dyes. Examples that may be mentioned include: C.I. Solvent Black 45, 27; C.I. Reactive Black 31, C.I. Direct Black 168, C.I. Solubilized Sulfur Black 1.

Inorganic pigments, such as TiO₂ or BaSO₄, for example, are used in mixtures for brightening. Also suitable are mixtures comprising effect pigments, such as pearlescent pigments, Fe₂O₃ pigments (®Paliocroms) and also pigments based on cholesteric polymers, which give colors that differ depending on the viewing angle. Further inorganic pigments, such as carbon black, for example, especially C.I. Pigment Black 7, are used to prepare black toners.

The present invention additionally provides an electrophotographic toner, powder or powder coating containing from 30 to 99.99% by weight, preferably from 40 to 99.5% by weight, of customary binder, for example a styrene, styrene-acrylate, styrene-butadiene, acrylate, urethane, acrylic, polyester or epoxy resin or a combination of the last two, from 0.01 to 50% by weight, preferably from 0.05 to 20% by weight, with particular preference from 0.1 to 5% by weight of at least one iron azo complex compound, and, if desired, from 0.001 to 50% by weight, preferably from 0.05 to 20% by weight, of a colorant, based in each case on the overall weight of the electrophotographic toner, powder or powder coating material.

Furthermore, the compounds described in accordance with the invention comprising “free-flow agents” may be applied as an additional charge control element in suspended form or as a dry blend. The compounds described in accordance with the invention may also be used for a carrier coating.

It has additionally been found that the iron azo complex compounds of the formula (I) are suitable as colorants in inkjet inks on an aqueous basis (microemulsion inks) and on a nonaqueous (solvent-based) basis, and also in inks which operate in accordance with the hot-melt technique, and also in UV (ultraviolet)-curing inks.

The present invention additionally provides inkjet recording liquids which comprise one or more of the iron azo complex compounds. The finished recording liquids generally contain a total of from 0.5 to 15% by weight, preferably from 1.5 to 8% by weight (calculated on a dry basis) of one or more, e.g., 2 or 3, of the compounds of the formula (I).

Microemulsion inks are based on organic solvents, water and, if desired, an additional hydrotropic substance (interface mediator). Nonaqueous inks contain substantially organic solvents and, if desired, a hydrotropic substance.

Microemulsion inks contain preferably from 0.5 to 15% by weight, in particular from 1.5 to 8% by weight, of a compound of the formula (I), from 5 to 99% by weight of water and from 0.5 to 94.5% by weight of organic solvent and/or hydrotropic compound.

Solvent-based inkjet inks contain preferably from 0.5 to 15% by weight of one or more compounds of the formula (I), from 85 to 99.5% by weight of organic solvent and/or hydrotropic compounds.

Hot-melt inks are based mostly on waxes, fatty acids, fatty alcohols or sulfonamides which are solid at room temperature and which become liquid on heating, the preferred melting range being between about 60° C. and about 140° C. The invention additionally provides a hot-melt inkjet ink consisting substantially of from 20 to 90% by weight of wax and from 1 to 10% by weight of the iron azo complex compounds. It is also possible for from 0 to 20% by weight of an additional polymer (as “dye dissolver”), from 0 to 5% by weight of dispersing auxiliary, from 0 to 20% by weight of viscosity modifier, from 0 to 20% by weight of plasticizer, from 0 to 10% by weight of tack additive, from 0 to 10% by weight of transparency stabilizer (prevents, for example, crystallization of the waxes), and from 0 to 2% by weight of antioxidant to be present. Typical additives and auxiliaries are described, for example, in US-A 5,560,760.

UV inks contain preferably from 0.5 to 15% by weight of one or more compounds of the formula (I), from 50 to 99.5% by weight of photopolymerizable monomers (containing for example acyl, epoxy, vinyl groups), photoinitiators and/or further additives, as described for example in U.S. Pat. No. 5,275,646).

Water used to prepare the recording liquids is preferably employed in the form of distilled water or deionized water.

The solvents present in the recording liquids may comprise an organic solvent or a mixture of such solvents. Examples of suitable solvents are monohydric or polyhydric alcohols, their ethers and esters, e.g., alkanols, especially those having 1 to 4 carbon atoms, such as methanol, ethanol, propanol, isopropanol, butanol, isobutanol; dihydric or trihydric alcohols, especially those having 2 to 5 carbon atoms, examples being ethylene glycol, propylene glycol, 1,3-propanediol, 1,4-butanediol, 1,5-pentanediol, 1,6-hexanediol, 1,2,6-hexanetriol, gicyerol, diethylene glycol, dipropylene glycol, triethylene glycol, polyethylene glycol, tripropylene glycol, polypropylene glycol; lower alkyl ethers of polyhydric alcohols, such as ethylene glycol monomethyl, monoethyl or monobutyl ether, triethylene glycol monomethyl or monoethyl ether; ketone and ketone alcohols such as acetone, methyl ethyl ketone, diethyl ketone, methyl isobutyl ketone, methyl pentyl ketone, cyclopentanone, cyclohexanone, diacetone alcohol; amides, such as dimethylformamide, dimethylacetamide, N-methylpyrrolidone, toluene, and n-hexane.

As hydrotropic compounds, which may if desired also serve as solvents, it is possible to use, for example, formamide, urea, tetramethylurea, ε-caprolactam, ethylene glycol, diethylene glycol, triethylene glycol, polyethylene glycol, butyl glycol, methylcellosolve, glycerol, N-methylpyrrolidone, 1,3-diethyl-2-imidazolidinone, thiodiglycol, sodium benzenesulfonate, Na xylenesulfonate, Na toluenesulfonate, sodium cumenesulfonate, Na dodecylsulfonate, Na benzoate, Na salicylate or sodium butyl monoglycol sulfate.

Furthermore, the recording liquids of the invention may comprise customary additives, examples being preservatives, cationic, anionic or nonionic surface-active substances (surfactants and wetting agents), and also viscosity regulators, e.g., polyvinyl alcohol, cellulose derivatives, or water-soluble natural or synthetic resins as film formers and/or binders for increasing the adhesion and abrasion resistance.

Amines, such as ethanolamine, diethanolamine, triethanolamine, N,N-dimethyl-ethanolamine or diisopropylamine, for example, serve primarily to increase the pH of the recording liquid. They are normally present at from 0 to 10% by weight, preferably from 0.5 to 5% by weight, in the recording liquid.

The inkjet inks of the invention may be prepared by dispersing the iron azo complex compounds of the formula (I) as powders, as a preparation, as a suspension or as presscakes into the microemulsion medium or into the nonaqueous medium or into the wax for preparing a hot-melt inkjet ink. The presscake may also be a highly concentrated presscake, in particular a spray-dried presscake.

Furthermore, compounds of the formula (I) are also suitable as colorants for color filters, both for subtractive and for additive color production (P. Gregory “Topics in Applied Chemistry: High Technology Application of Organic Colorants” Plenum Press, New York 1991, pp. 15-25).

### EXAMPLES

In the examples below, parts and percentages are by weight.

### Preparation Example 1

a) 60.7 g (0.3 mol) of 2-amino-5-(methylaminosulfonyl)phenol were stirred into a mixture of 450 g of water and 120 g of 30% strength by weight aqueous HCl. Following the addition of 75 g of ice, the amine was diazotized by adding 79 g of 4N sodium nitrite solution. The suspension obtained was stirred at 0° C. for 3 hours. Then a solution of 22.2 g of resorcinol (0.2 mol) in 100 g of water and 21.2 g of sodium carbonate was slowly added dropwise. The mixture obtained was stirred at room temperature for 8 hours and brought to a pH of 1.5 by adding 30% strength by weight aqueous HCl. The precipitate was filtered off, washed with 4000 g of water and dried.

b) 80 g of the monoazo dye prepared in a) were suspended in a mixture of 300 g of water, 15 g of dipropylene glycol monomethyl ether and 39.4 g of sodium carbonate. After heating at 98° C. for 1 hour, a solution of 25.2 g of FeCl₃×6H₂O in 130 g of water were slowly added dropwise, in the course of which a bulky precipitate of the iron azo complex was formed. Over the course of 2 hours, the temperature was lowered to 30° C. with vigorous stirring and the suspension was slowly reacted with a solution of 186 parts of ®Primene 81 R (C₁₂-C₁₄-t-alkylamines, Rohm & Haas) in 80 g of water and 12 g of 30% strength by weight aqueous HCl. The resulting precipitate was adjusted to a pH of 6.5 by adding about 23 g of 30% by weight aqueous HCl.

The mixture was stirred at room temperature for 1 hour and filtered, and the residue was washed with a solution of 100 g of acetic acid and 900 g of water and then dried. This gave an iron azo complex dye of the formula

[chemical structure]

### Characterization

Brown, water-insoluble powder, readily soluble in ethanol (to 400 g/liter)

| | |
|---|---|
| pH: | 5 |
| Conductivity | 410 μS/cm |
| Residual moisture content | 0.6% (Karl-Fischer method) |
| X-ray diffraction: | There is no reflexion peak between two theta |
| 4.0 | and two theta 36.0, i.e., the compound is |
| | x-ray-amorphous |
| DTA: | Decomposition begins from 200° C. (at |
| | 3° C./min heating rate) |
| Particle size distribution: | d₅₀ < 71 μm |

Use Example 1.1

1 part of the compound from Preparation Example 1 is incorporated homogeneously using a kneading apparatus over the course of 30 minutes into 95 parts of a toner binder 60:40 styrene-n-butyl methacrylate (®Dialec S309). The composition is then ground on a universal laboratory mill and subsequently classified in a centrifugal classifier. The desired particle fraction (4 to 25 μm) is activated with a carrier comprising styrene-acrylate-coated magnetite particles of size 50 to 200 μm.

Measurement is carried out on a customary g/m measurement stand. By using a sieve having a mesh size of 25 μm it is ensured that no carrier is entrained when the toner is blown out. The measurements are made at about 50% relative atmospheric humidity. As a function of the activation period, the following q/m values [μC/g] are measured:

| Activation period | Charge q/m [μC/g] |
|---|---|
| 10 min | −22 |
| 30 min | −30 |
| 2 h | −35 |
| 24 h | −35 |

Use Example 1.2

6 parts of the compound from Preparation Example 1 are dissolved with stirring (paddle stirrer or dissolver) in 94 parts of methyl ethyl ketone. The inkjet ink thus obtained shows good to very good fastness properties on inkjet paper (lightfastness: 5-6, evaluated in accordance with the blue scale (ISO 12040/DIN 16525), where the lowest score, 1, denotes very poor lightfastness and the highest score, 8, denotes very high lightfastness. 1=very low, 2=low, 3=moderate, 4=fairly good, 5=good, 6=very good, 7=excellent, 8=outstanding.

### Lightfastness Comparative Examples

In accordance with the method described above, the lightfastness of the compounds described in JP-A-62-129 358, Examples 8, 9 and 14, was measured. For all three compounds, the lightfastness was poor to moderate (2-3).

Use Example 1.3

5 parts of the compound from Preparation Example 1 are dissolved with stirring in 30 parts of glycol ether (®Dowanol EPh, Dow Chemical). This solution is subsequently added with stirring to a solution of 50 parts of deionized water with 15 parts of xylenesulfonate.

The microemulsion ink thus obtained has the following composition:

30 parts of glycol ether,

5 parts of compound from Preparation Example 1,

15 parts of xylenesulfonate (interface mediator, hydrotropic substance),

50 parts of deionized water.

This gives an inkjet ink having high lightfastness (5-6) and good passage through the nozzles.

### Preparation Example 2

a) 78.1 g (0.3 mol) of 2-amino-4-(3′-methoxypropylaminosulfonyl)phenol were stirred into a mixture of 600 g of water and 120 g of 30% strength by weight aqueous HCl. Following the addition of 75 g of ice, the amine was diazotized by adding 79 g of 4N sodium nitrite solution. The suspension obtained was stirred at 0° C. for 3 hours. Then a solution of 22.2 g (0.2 mol) of resorcinol and 100 g of water and 21.2 g of sodium carbonate was slowly added dropwise. The mixture obtained was stirred at room temperature for 8 hours and brought to a pH of 1.5 by adding 30% strength by weight aqueous HCl. The precipitate was filtered off, washed with 4000 g of water and dried.

b) 96.2 g of the monoazo dye prepared in a) were suspended in a mixture of 300 g of water, 15 g of dipropylene glycol monomethyl ether and 39.4 g of sodium carbonate. After heating at 98° C. for 1 hour, a solution of 25.2 g of FeCl₃×6H₂O in 130 g of water was slowly added dropwise, during which a bulky precipitate of the iron azo complex was formed. Over the course of 2 hours, the temperature was reduced to 30° C. with vigorous stirring and the suspension was slowly reacted with a solution of 186 g of ®Primene 81 R (C₁₂-C₁₄-t-alkylamines, Rohm & Haas) in 80 g of water and 12 g of 30% strength by weight aqueous HCl. The resulting precipitate was adjusted to a pH of 6.5 by adding about 23 g of 30% strength by weight aqueous HCl.

The mixture was stirred at room temperature for 1 hour and filtered and the residue was washed salt-free with water and then dried. This gave a compound of the formula

[chemical structure]

| Characterization | |
|---|---|
| pH: | 6.4 |
| Conductivity | 610 μS/cm |
| Residual moisture content | 0.8% (Karl-Fischer method) |
| X-ray diffraction: | There is no reflexion peak between two theta |
| | 4.0 |
| | and two theta 36.0, i.e., the compound is |
| | x-ray-amorphous |
| DTA: | Decomposition begins from 200° C. (at |
| | 3° C./min |
| | heating rate) |
| Particle size distribution: | d₅₀ = 78 μm |

Use Example 2.1

The procedure of Use Example 1.1 is repeated but incorporating now 1 part of the compound from Preparation Example 2 rather than 1 part of the compound from Preparation Example 1.

As a function of the activation period, the following q/m values are measured:

| Activation period | q/m [μC/g] |
|---|---|
| 10 min | −11 |
| 30 min | −19 |
| 2 h | −29 |
| 24 h | −29 |

Use Example 2.2

1 part of the compound from Preparation Example 2 is incorporated homogeneously as described in Use Example 1.1 into 99 parts of a powder coating binder based on a carboxyl-containing polyester resin, e.g., ®Crylcoat 430 (UCB, Belgium).

To determine the deposition rate, 50 g of the test powder coating material are sprayed with a defined pressure through a triboelectric spray gun. By differential weighing it is possible to determine the amount of powder coating deposited and to define a deposition rate in %, and also, by means of the charge transfer, to derive a current flow [μA].

| Pressure [bar] | Current [μA] | Deposition rate [%] |
|---|---|---|
| 5 | 0.7 | 80 |
| 3 | 0.4 | 55 |

Use Example 3 (comparative)

To determine the deposition rate of the straight powder coating binder ®Crylcoat 430, the procedure described above is repeated but without incorporation of an additive.

| Pressure [bar] | Current [μA] | Deposition rate [%] |
|---|---|---|
| 3 | 0.1 | 5 |

Use Example 4 (comparative)

The procedure of Use Example 1.1 was repeated, using solely the straight toner binder without additions.

As a function of the activation period, the following q/m values are measured:

| Activation period | Charge q/m [μC/g] |
|---|---|
| 10 min | −8 |
| 30 min | −12 |
| 2 h | −18 |
| 24 h | −19 |

1. A method of imparting color to and controlling the electrostatic charge of electrophotographic toners and developers, powder coating materials, electret materials, inkjet inks and color filters, comprising the step of adding an iron azo complex compound of the formula (I) to the binder of said toners and developers, powder coating materials, to the electret polymer, the ink base, and the filter material, [chemical structure]
in which
R₁ is hydrogen or a radical of the formula 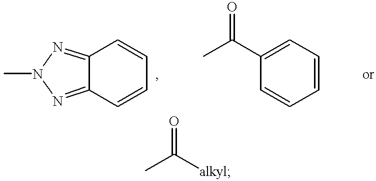
R₂ and R₃ are identical or different and are hydrogen, alkyl, alkoxyalkyl, cycloalkyl or aryl;
R₄ is hydrogen or hydroxyl;
R₅ is hydrogen, alkyl, alkoxyalkyl or cycloalkyl; and
R₆ is hydrogen or a group of the formula (2) 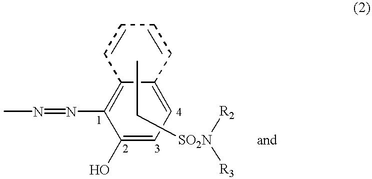
R₇⁺ is ammonium or aliphatic, alicyclic or heterocyclic ammonium.

2. The method as claimed in claim 1, wherein R₇⁺ is ammonium, mono-(C₅-C₂₀-alkyl)-ammonium, di-(C₅-C₂₀-alkyl)-ammonium, tri-(C₅-C₂₀-alkyl)-ammonium, tri-(C₅-C₂₀-alkyl)-methyl-ammonium, 4-amino-2,2,6,6-tetra(C₁-C₂-alkyl)-piperidinium, 4-hydroxy-2,2,6,6-tetra(C₁-C₂-alkyl)-piperidinium or 4-keto-2,2,6,6-tetra(C₁-C₂-alkyl)-piperidinium.

3. The method as claimed in claim 1, wherein R₇⁺ is monooctylammonium, 2-ethylhexylammonium, 4-amino-2,2,6,6-tetramethylpiperidinium, 4-hydroxy-2,2,6,6-tetramethylpiperidinium, 4-keto-2,2,6,6-tetramethylpiperidinium or tri-(C₁₀-C₁₆-alkyl)methyl-ammonium.

4. An electrophotographic toner comprising
from 30 to 99.99% by weight of a binder,
from 0.01 to 50% by weight of at least one iron azo complex compound of the formula (I) as set forth in claim 1,
optionally from 0.01 to 50% by weight of a further charge control agent,
and optionally from 0.001 to 50% by weight of a colorant, based in each case on the overall weight (100% by weight) of the electrophotographic toner.

5. The electrophotographic toner as claimed in claim 4, wherein the further charge control agent is a compound from the group of the triphenylmethanes; ammonium and immonium compounds, iminium compounds; fluorinated ammonium and fluorinated immonium compounds; biscationic acid amides; polymeric ammonium compounds; diallylammonium compounds; aryl sulfide derivatives, phenol derivatives; phosphonium compounds and fluorinated phosphonium compounds; calix(n)arenes, cyclically linked oligosaccharides and their derivatives, interpolyelectrolyte complexes; polyester salts; salicylate metal complexes and salicylate nonmetal complexes, hydroxycarboxylic acid metal complexes and hydroxycarboxylic acid nonmetal complexes, benzimidazolones; azines, thiazines or oxazines.

6. A powder coating material comprising
from 30 to 99.99% by weight of a binder,
from 0.01 to 50% by weight of at least one iron azo complex compound of the formula (I) as set forth in claim 1,
optionally from 0.01 to 50% by weight of a further charge control agent,
and optionally from 0.001 to 50% by weight of a colorant, based in each case on the overall weight (100% by weight) of the powder coating material.

7. The powder coating material as claimed in claim 6, wherein the further charge control agent is a compound from the group of the triphenylmethanes; ammonium and immonium compounds, iminium compounds; fluorinated ammonium and fluorinated immonium compounds; biscationic acid amides; polymeric ammonium compounds; diallylammonium compounds; aryl sulfide derivatives, phenol derivatives; phosphonium compounds and fluorinated phosphonium compounds; calix(n)arenes, cyclically linked oligosaccharides and their derivatives, interpolyelectrolyte complexes; polyester salts; salicylate metal complexes and salicylate nonmetal complexes, hydroxycarboxylic acid metal complexes and hydroxycarboxylic acid nonmetal complexes, benzimidazolones; azines, thiazines or oxazines.

8. An inkjet ink containing from 0.5 to 15% by weight of at least one Fe azo complex compound of the formula (I) as set forth in claim 1.

9. The inkjet ink as claimed in claim 8, consisting substantially of from 0.5 to 15% by weight of at least one Fe azo complex compound of the formula (I) as set forth in claim 1, and
from 5 to 99% by weight of water, and from 0.5 to 94.5% by weight of an organic solvent, of a hydrotropic compound or of a mixture thereof.

10. The inkjet ink as claimed in claim 8, consisting substantially of from 0.5 to 15% by weight of at least one Fe azo complex compound of the formula (I) as set forth in claim 1, and
from 0.5 to 99.5% by weight of an organic solvent, of a hydrotropic compound or of a mixture thereof.

11. The inkjet ink as claimed in claim 8, consisting substantially of from 1 to 10% by weight of at least one Fe azo complex compound of the formula (I) as set forth in claim 1, and from 20 to 90% by weight of wax.
